(19) United States
(12) Patent Application Publication
(10) Pub. No.: US 2011/0279940 A1
(43) Pub. Date: Nov. 17, 2011

(54) SYSTEM AND METHOD FOR PROVIDING OVERVOLTAGE PROTECTION

(76) Inventor: Jian Xu, Windsor (CA)

(21) Appl. No.: 12/778,181

(22) Filed: May 12, 2010

(51) Int. Cl. H02H 3/20

(52) U.S. Cl. 361/91.1

(57) ABSTRACT

An overvoltage protection circuit includes a voltage clamping device having a predefined voltage threshold at which it starts conducting to prevent an overvoltage condition. A switch is operable to control a flow of current from a power source to the voltage clamping device. The switch is OFF to prevent a flow of current from the power source to the voltage clamping device in response to a voltage of the power source being less than the voltage threshold such that the voltage clamping device does not exhibit a leakage current. The switch is ON to permit a flow of current from the power source to the voltage clamping device in response to the voltage of the power source being equal to or greater than the voltage threshold.

### BACKGROUND

This disclosure relates to overvoltage protection, and more particularly to a system and method for providing overvoltage protection.

Zener diodes have been used to provide overvoltage protection such that if an input voltage is less than a breakdown voltage of the zener diode, the zener diode is not conducting and blocks a flow of current to ground, and if the input voltage is greater than or equal to the breakdown voltage the zener diode starts conducting, permitting a flow of current and clamping the voltage so that the overvoltage condition does not damage various circuit components.

However, zener diodes exhibit leakage current that passes through the zener diode even when the input voltage is less than the breakdown voltage and the zener diode is not conducting. If the zener diode is providing overvoltage protection for a low power load, the leakage current can possibly be greater than an amount of current used by the load, which is inefficient, especially when the input voltage is close to but still under the breakdown voltage of the zener diode.

### SUMMARY

An overvoltage protection circuit includes a voltage clamping device having a predefined voltage threshold at which it starts conducting to prevent an overvoltage condition. A switch is operable to control a flow of current from a power source to the voltage clamping device. The switch is OFF to prevent a flow of current from the power source to the voltage clamping device in response to a voltage of the power source being less than the voltage threshold such that the voltage clamping device does not exhibit a leakage current. The switch is ON to permit a flow of current from the power source to the voltage clamping device in response to the voltage of the power source being equal to or greater than the voltage threshold.

An overvoltage protection circuit includes a switch and a voltage clamping device. A switch control controls the switch such that the switch only turns ON to permit a flow of current to the voltage clamping device in response to an input voltage exceeding a voltage threshold.

A method of providing overvoltage protection passes an electric current through a voltage clamping device to prevent an overvoltage condition in response to a power source voltage exceeding a voltage threshold of the voltage clamping device. A flow of current from the power source to the voltage clamping device is prevented in response to a voltage of the power source being less than the voltage threshold of the voltage clamping device such that the voltage clamping device does not exhibit a leakage current.

These and other features of the present invention can be best understood from the following specification and drawings, the following of which is a brief description.

### BRIEF DESCRIPTION OF THE DRAWINGS

FIG. 1 schematically illustrates an example overvoltage protection circuit.

### DETAILED DESCRIPTION

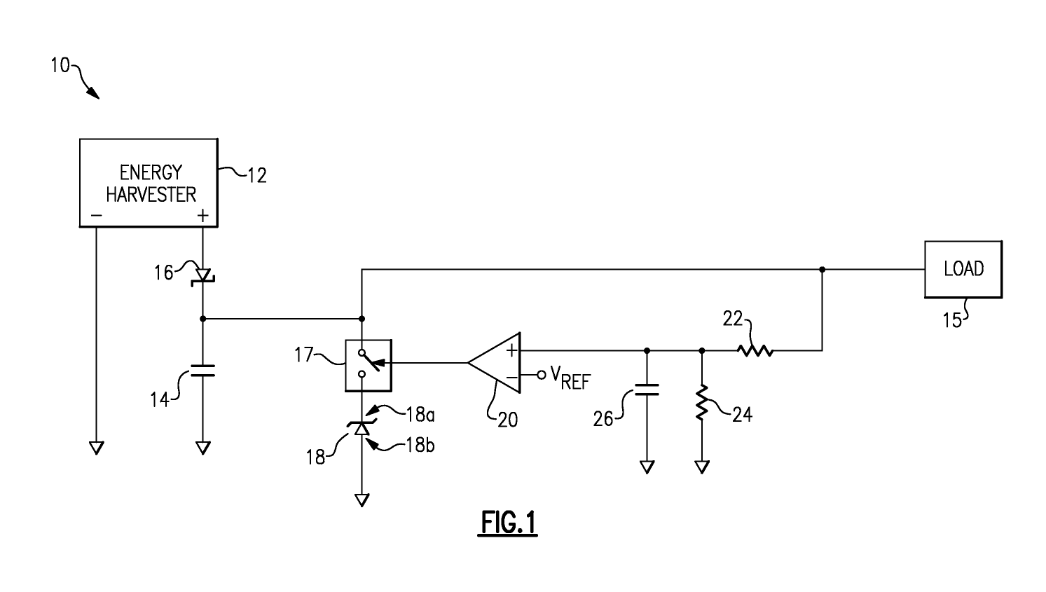

FIG. 1 schematically illustrates an example overvoltage protection circuit 10. The circuit 10 includes an energy harvester 12 that is operable to harvest energy from environmental conditions. An energy storage device 14 stores energy harvested by the energy harvester 12. The energy harvester 12 and energy storage device 14 are used to power a load 15.

A diode 16 is connected to an output of the energy harvester 12 and prevents the energy storage device 14 from backcharging into the energy harvester 12. In one example the energy harvester 12 includes one or more photovoltaic cells operable to harvest solar energy. In one example the energy storage device 14 includes one or more capacitors. In one example the diode 16 is a Schottky diode. Of course, other types of energy harvesters, energy storage devices, and diodes could be used.

A switch 17 controls a flow of current from the energy storage device 14 to a voltage clamping device (“VCD”) 18. The VCD 18 provides overvoltage protection to the circuit 10. The VCD may be a zener diode, transient voltage suppressor, or a metal oxide varistor, for example. VCDs such as zener diodes are characterized by having a voltage threshold (a “breakdown voltage” in the case of a zener diode) such that if a voltage below the voltage threshold is applied to the VCD 18 then the VCD 18 is not conducting and blocks a flow of current from its input 18a to its output 18b, and if a voltage greater than or equal to the voltage threshold is applied to the VCD 18 then the VCD 18 begins conducting and permits a flow of current from its input 18a to its output 18b to clamp its input voltage (e.g. voltage provided by energy storage device 14). However, even when the input voltage is below the voltage threshold, VCDs such as zener diodes tend to exhibit a leakage current that still passes from the input 18a to the output 18b.

To prevent the VCD 18 from exhibiting a leakage current below the voltage threshold of the VCD 18, the switch 17 prevents current from flowing from the energy storage device 14 to the VCD 18 when a voltage of the energy storage device 14 is less than a voltage threshold (e.g. the voltage threshold of the VCD 18). In this configuration, the only time current flows to the VCD 18 is when it is known that the input voltage is equal to or above the voltage threshold of the VCD, or when the input voltage is within 2 volts less than the voltage threshold of the VCD, such that current only flows to the VCD 18 when the VCD will start conducting to provide an overvoltage protection to the circuit 10.

An output of comparator 20 is connected to a gate of the switch 17, enabling the comparator 20 to control the switch 17. The switch 17 may be a solid state switch or an air gap relay, for example. Resistors 22, 24 form a voltage divider which along with noise-filtering capacitor 26 defines the voltage threshold for the comparator 20 that is greater than or equal to the voltage threshold of the VCD 18 (or as described above is within 2 volts less than the voltage threshold of the VCD 18). Therefore, if a voltage of the energy storage device 14 is less than the comparator threshold, the comparator 20 output is low which maintains the switch 17 in an OFF state (and prevents a leakage current). If a voltage of the energy storage device 14 exceeds the comparator threshold, then the comparator 20 output is high and the switch 17 turns ON permitting a flow of current to the VCD 18 at a voltage causing the VCD 18 to start conducting and permit a flow of current to ground to clamp the voltage, protecting the circuit 10 and the load 15 from an overvoltage condition. The comparator 20 and resistors 22, 24 may be carefully chosen so that their energy consumption is much lower than the one leaked through VCD 18 when the input voltage is close to but lower than the voltage threshold of the VCD 18.

If the load 15 is a low power load, such as a passive infrared sensor, a VCD leakage current can cause significant inefficiency, as the leakage current may dissipate more power than is dissipated by the actual load 15. The circuit 10 can effectively reduce this inefficiency by preventing or significantly reducing a leakage current from passing through the zener diode 18. Of course, the circuit 10 may be used for other loads that would not be considered low power loads.

Also, although the circuit 10 has been described as including the energy harvester 12 and the energy storage device 14 as a power source, it is understood that this is only a non-limiting example, and it is further understood that other power sources could be used in the circuit 10.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An overvoltage protection circuit, comprising:
a voltage clamping device having a predefined voltage threshold at which it starts conducting to prevent an overvoltage condition; and
a switch operable to control a flow of current from a power source to the voltage clamping device, the switch being OFF to prevent a flow of current from the power source to the voltage clamping device in response to a voltage of the power source being less than the voltage threshold such that the voltage clamping device does not exhibit a leakage current, and the switch being ON to permit a flow of current from the power source to the voltage clamping device in response to the voltage of the power source being equal to or greater than the voltage threshold.

2. The circuit of claim 1, including;
a comparator having an output connected to a control of the switch, the comparator only turning ON the switch to permit a flow of current to the voltage clamping device in response to the voltage of the power source exceeding a comparator threshold, the comparator threshold being greater than or equal to the voltage threshold of the voltage clamping device.

3. The circuit of claim 2, wherein the comparator also turns the switch ON to permit a flow of current to the voltage clamping device in response to the voltage of the power source being less than the voltage threshold of the voltage clamping device by an amount of 2 volts or less.

4. The circuit of claim 1, wherein the power source includes:
an energy harvester operable to harvest energy from environmental conditions; and
an energy storage device operable to store energy harvested by the energy harvester.

5. The circuit of claim 4, wherein the energy harvesting device includes at least one solar cell.

6. The circuit of claim 4, including a diode connected to an output of the energy harvester, the diode being operable to prevent the energy storage device from backcharging into the energy harvester.

7. The circuit of claim 1, wherein the voltage clamping device includes at least one of a zener diode, a transient voltage suppressor, or a metal oxide varistor, and wherein the switch includes at least one of a solid state switch or an air gap relay.

8. The circuit of claim 1, wherein the voltage clamping device includes a zener diode, and wherein the voltage threshold of the voltage clamping device is a breakdown voltage of the zener diode.

9. An overvoltage protection circuit, comprising:
a switch;
a voltage clamping device; and
a switch control controlling the switch such that the switch only turns ON to permit a flow of current to the voltage clamping device in response to an input voltage exceeding a voltage threshold.

10. The circuit of claim 9, wherein the voltage threshold is great than or equal to a breakdown voltage of the voltage clamping device, or is within 2 volts less than the breakdown voltage of the voltage clamping device.

11. The circuit of claim 98, wherein the voltage clamping device has a predefined breakdown voltage at which it is conducting and clamps an input voltage to permit a flow of current and prevent an overvoltage condition.

12. The circuit of claim 9, wherein the input voltage comes from a power source including:
an energy harvester operable to harvest energy from environmental conditions; and
an energy storage device operable to store energy harvested by the energy harvester.

13. The circuit of claim 11, including a diode connected to an output of the energy harvester, the diode being operable to prevent the energy storage device from backcharging into the energy harvester.

14. The circuit of claim 8, wherein the voltage clamping device includes at least one of a zener diode, a transient voltage suppressor, or a metal oxide varistor, and wherein the voltage the switch includes at least one of a solid state switch or an air gap relay.

15. A method of providing overvoltage protection, comprising:
passing an electric current through a voltage clamping device to prevent an overvoltage condition in response to a power source voltage exceeding a voltage threshold of the voltage clamping device; and
preventing a flow of current from the power source to the voltage clamping device in response to a voltage of the power source being less than the voltage threshold of the voltage clamping device such that the voltage clamping device does not exhibit a leakage current.

16. The method of claim 15, including:
connecting the power source to an input of a switch; and
connecting the voltage clamping device to an output of the switch, the switch controlling a flow of current to the voltage clamping device.

17. The method of claim 16, wherein the voltage clamping devices includes at least one of a zener diode, a transient voltage suppressor, or a metal oxide varistor, and wherein the voltage the switch includes at least one of a solid state switch or an air gap relay.

18. The method of claim 16, including:
connecting a comparator to a control input of the switch such that switch only turns ON to permit a flow of current to the voltage clamping device in response to a voltage of the power source exceeding a voltage threshold.

19. The method of claim 17, wherein the voltage at which said step of passing an electric current through a voltage clamping device is performed is a voltage greater than or equal to the voltage threshold of the voltage clamping device, or is within 2 volts less than the voltage threshold of the voltage clamping device.

20. The method of claim 15, wherein the power source includes an energy harvester and an energy storage device, the method including:
using an energy harvester to harvest energy from environmental conditions;
storing the harvested energy in an energy storage device; and
connecting a diode between the energy harvester and the energy storage device to prevent the energy storage device from backcharging into the energy harvester.
